(19) United States
(12) Patent Application Publication
(10) Pub. No.: US 2018/0149181 A1
(43) Pub. Date: May 31, 2018

(54) FASTENER AND METHOD OF PRODUCING THE SAME

(71) Applicant: NEWFREY LLC, New Britain, CT (US)

(72) Inventor: Sascha GRAMSCH-KEMPKES, Giessen (DE)

(21) Appl. No.: 15/816,289

(22) Filed: Nov. 17, 2017

(30) Foreign Application Priority Data
Nov. 30, 2016 (EP) 16201497.1

(51) Int. Cl. F16B 11/00; F16B 39/22; F16B 41/00; B29C 65/48; B29C 65/10

(52) U.S. Cl. CPC F16B 11/006; F16B 39/225; B29L 2031/727; B29C 65/4805; B29C 65/10; F16B 41/002

(57) ABSTRACT

A fastener joinable to a workpiece, the fastener comprising: a shaft-shaped anchor section that extends along an anchor axis (Xa) between a first end portion and a second end portion; a flange section formed on and extending radially from the first end portion of the anchor section; and an application section located on the flange section. A pre-applied joining material is located on the application section and is at least partially in a solid state. The joining material includes a first adhesive material and a second different adhesive material, and the first adhesive material completely covers the second adhesive material.

### CROSS-REFERENCE TO RELATED APPLICATION

This application claims priority from European Patent Application No. 16201497.1, filed on Nov. 30, 2016, the disclosure of which is incorporated herein by reference.

### BACKGROUND OF THE INVENTION

The present invention relates to a fastener having pre-applied joining material, and a method of producing the same.

It is known, for example, in the technical field of joining fasteners to workpieces to weld metallic bolts to metallic workpieces. This method, known as “stud welding”, is used, in particular, in the automotive industry in order to weld bolts to car body panels, wherein fixing clips made of plastic are fixed to connect to the bolts, to which fixing clips cables, wires etc. are fixed.

Due to the fact that composite materials that are able to be welded less well or are non-metallic are being increasingly used, for example, in car body construction, such as plastics, fibre composite components, etc., the adhesive bonding technique (or gluing technique or adhering technique) has been established as a joining method in car body panel construction in particular. Instead of welding the bolts to workpieces, they are adhesively bonded (or glued) to the workpiece.

Document DE102014118973 discloses a fastener having a joining face which has an application region. A joining material (or an adhesive) at least partially covers the application region. The adhesive is generally applied in a heated state and is then cooled down again. The fastener produced in this way is then transported with the adhesive, for example from a place of production to a place where the fastener is to be adhered or bonded or glued to a support face of a workpiece, such as a car body panel, for example.

During storage and transportation, it is important to avoid an unwanted chemical crosslinking reaction of the joining material before the actual adhering process. In order to avoid this unwanted chemical crosslinking reaction of the joining material, nowadays, a cooling chain is used. For example, the fasteners are stored and transported in cool boxes. More particularly, the fastener is stored in a frozen state and also transported in a refrigerated state in order to ensure a storage period that lasts several months.

Using cooling chains is particularly complicated and expensive. Monitoring the temperature may be necessary and there is a risk of the cooling chain breaking during storage and/or transportation.

The object of the present invention is thus to specify an improved fastener and an improved method for the production thereof which preferably avoids an unwanted chemical crosslinking reaction of the joining material before the actual adhesive process, which allows for good joining results and which is simple to manufacture.

### SUMMARY OF THE INVENTION

The object mentioned above is solved by means of a fastener that can be joined to a workpiece, having:
a shaft-shaped anchor section that extends along an anchor axis between a first and a second end portion, and
a flange section running transversely thereto, wherein the flange section is formed on the first end portion of the anchor section, wherein the flange section at least partially forms an application section,
a joining material, wherein the joining material is pre-applied to the application section, wherein the joining material in the solid state lies on the application section,

characterised in that the joining material has a first adhesive material and a second, different adhesive material, and wherein the first adhesive material covers the second adhesive material.

The joining material having two different and separated adhesive materials allows for a stable state of the fastener. Only the first adhesive material is visible from outside and should therefore have a solid state. The first adhesive material can remain rigid and solid at room temperature. The second adhesive material is enclosed between the application section and the first adhesive material and, during storage or transportation, the first and second adhesive materials are prevented from mixing with each other, which also avoids an unwanted chemical crosslinking reaction before the actual adhesive process. Mixing the first and second adhesive materials takes place directly at the place where the fastener is to be adhered to a support face of a workpiece, such as a car body panel, for example.

According to a further preferred embodiment, the second adhesive material is liquid and/or paste-like and/or rigid (solid). Since the second adhesive material is enclosed between the application section and the first adhesive material, it can have different states and, in particular, can be liquid or paste-like, without leading to a loss of the joining material (during storage and/or transportation).

In a preferred embodiment, the first adhesive material is an adhesive resin. An adhesive resin can have a solid state and hold well to the application face of the fastener. In a further preferred embodiment, the first adhesive material is an epoxy resin. Epoxy resin is advantageous because it forms a good protection layer and can be mixed well. Furthermore, the high achievable adhesive strength of epoxy resin is advantageous.

In a preferred embodiment, the second adhesive material is an adhesive curing agent.

In a preferred embodiment, the second adhesive material is an accelerant.

In a particularly preferred embodiment, the first adhesive material and the second adhesive material are separated by means of a separating layer. The separating layer forms a physical barrier between the first adhesive material and the second adhesive material, which even more effectively avoids the unwanted mixing of the two materials.

According to a further preferred embodiment, the joining material has a crosslinking temperature, and the separating layer has a melting point that is lower than the crosslinking temperature. The separating layer is detached before the start of the crosslinking of the joining material.

According to a further preferred embodiment, the separating layer is a silicate layer.

In a preferred embodiment, the application section has an annular groove, and the first adhesive material extends in the annular groove. The annular groove holds the first adhesive material.

In another preferred embodiment, the application section has an annular groove, and the second adhesive material extends in the annular groove. The annular groove holds the second adhesive material. The first adhesive material then adheres to the second adhesive material.

In a preferred embodiment, the joining material forms a circular joining material strand having an inner wall which limits a central opening.

Furthermore, the above object is solved by means of a method for producing a fastener, having the following steps:
providing a composite component having a shaft-shaped anchor section that extends along an anchor axis between a first and a second end portion, and a flange section running transversely thereto, wherein the flange section is formed on the first end portion of the anchor section, wherein the flange section at least partially forms an application section,
applying a heated second adhesive material to at least the application section,
applying a heated first adhesive material to at least the second adhesive material such that the first adhesive material completely covers the second adhesive material.

The production of a fastener according to this method is simple.

In a preferred embodiment, a separating layer is applied before applying the heated first adhesive material to the second adhesive material.

According to a further preferred embodiment, the separating layer is applied by means of flame treatment with silicone dioxide (SiO2 or Pyrosil).

In a preferred embodiment, the method includes cooling the joining material down. Cooling the joining material down is preferably done as quickly as possible.

It is understood that the features that are explained above and are still to be explained below can not only be used in the respectively stated combination, but also in other combinations or on their own without leaving the scope of the present invention.

### BRIEF DESCRIPTION OF THE SEVERAL VIEWS OF THE DRAWINGS

Exemplary embodiments of the invention are depicted in the drawings and are explained in more detail in the following description. Here are shown:

FIG. 1 is a schematic cross-sectional view of a fastener according to the invention;

FIG. 2 is a schematic cross-sectional view of a fastener according to the invention according to an alternative embodiment;

FIG. 3 is the schematic steps of a method for producing the fastener of FIG. 1;

FIG. 4 is the schematic steps of a method for producing the fastener of FIG. 2;

FIG. 5a to FIG. 5c are several schematic embodiments of an application section with the second adhesive material;

FIG. 6A is a view of a fastener according to the invention having the joining material according to one embodiment;

FIG. 6B is a view of a fastener according to the invention having the joining material according to an alternative embodiment.

### DETAILED DESCRIPTION OF THE PREFERRED EMBODIMENTS

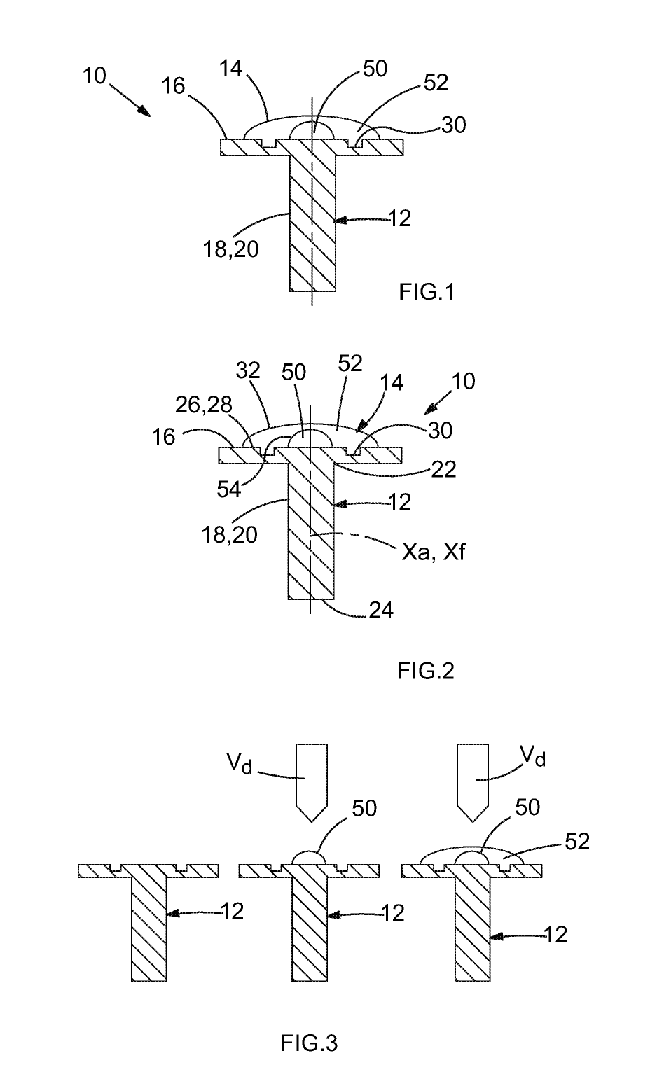

FIG. 1 schematically depicts an embodiment of a fastener 10 in longitudinal cross-section. The fastener has a joining component 12 and a joining material 14 pre-applied to the joining component 12.

The joining component 12 has a flange section 16 and a shaft-shaped anchor section 18. The joining component 12 is formed to be one piece.

In another embodiment, the joining component 12 can be formed to be in two parts. In this case, the flange section and the shaft-shaped anchor section, for example, are two different parts which are connected together.

The anchor section 18 has a base body 20, a first and a second end portion 22, 24. The base body 20 extends along an anchor axis Xa between the first end portion 22 and the second end portion 24. The base body 20 of the anchor section 18 can, in each case, assume the desired shaft shape. As depicted in FIG. 1, the base body 20 can have a circular cross-section, substantially constant over its length. In other embodiments, the anchor section could also have a rectangular, triangular, . . . cross-section. Similarly, in other embodiments, the base body could not be constant over its length.

The second end portion 24 of the anchor section 18 is preferably round, but other shapes of end portions could be provided. For example, the second end portion can be provided having cut edges.

The anchor section 18 is preferably made of steel. Other metals, such as aluminium or other materials, can also be used.

The flange section 16 extends from the first end portion 22. The flange section 16 is aligned, for example, to be circular and concentric relative to a flange axis Xf.

The joining component 12 has a joining face 26. This joining face 26 is preferably made of a metallic material. The joining face 26 is provided on the flange section 16, for example. The joining face 26 has an application section 28. The application section 28 is suitable for receiving a joining material. A retentive surface structure having elevations forming material undercuts 32 is formed, for example, on the application section 28. The production of material undercuts 32 on the joining face 26 is preferably described in DE102014118973.

An annular groove 30 can also, additionally or alternatively, be provided in the flange section 16 (or in the application section 28 of the joining component 12) (see FIG. 1). The annular groove has, for example, a radially internal inner wall and a radially external outer wall. The annular groove can be aligned to be concentric relative to the flange axis Xf. The depth of the annular groove is preferably greater than 0.1 times the height of the flange section 16 and smaller than 0.5 times the height of the flange section 16.

The application section 28 (for example having material undercuts 32 and/or an annular groove 30) is covered by a joining material 14. The joining material 14 is, for example, an adhesive which is applied to the application section 28 (or to the joining face). The joining material can be an adhesive drop or a circular adhesive strand, but other shapes can also be provided.

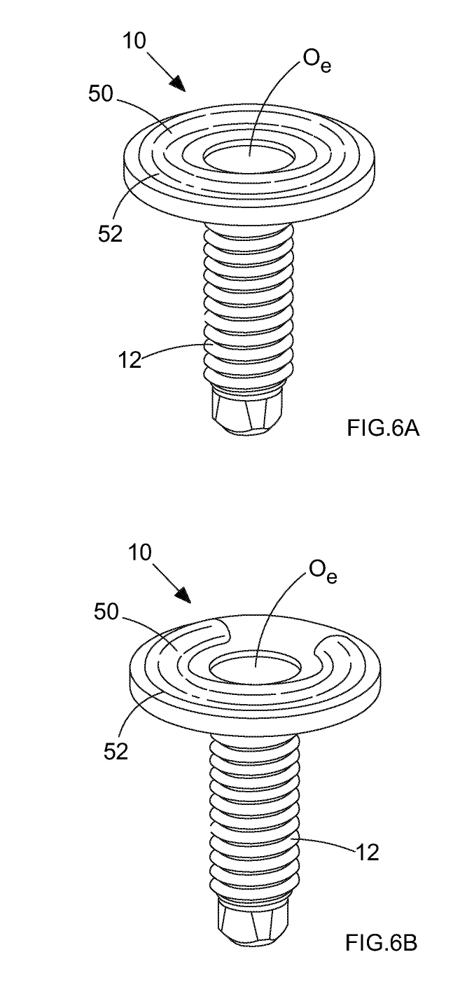

As depicted in FIG. 6A and FIG. 6B, the joining material can form a circular (or ring-shaped) joining material strand. The circular joining material strand can be centred on the anchor axis, or offset relative to the anchor axis. The circular joining material strand is provided with an inner wall that limits the central opening Oe. The circular joining material strand can have a semi-circular cross-section. The joining material can form a penetrating circular strand, as depicted in FIG. 6A, or a strand that is broken once or several times. In FIG. 6B, the joining material forms a circular arc, having two ends that are spaced apart from each other. For example, a receiver is provided in the central opening Oe.

The joining material has a first and a second different adhesive material. The second adhesive material is applied to the application section 28 and the first adhesive material covers the second adhesive material. The second adhesive material is enclosed between the application section 28 and the first adhesive material.

As depicted in FIGS. 1 and 2, the second adhesive material can be centred on the flange section. The second adhesive material can have a drop shape, but other shapes are also possible. Preferably, the second adhesive material can consist of several drops, as depicted in FIG. 5 a) to c), which are all covered by the first adhesive material. The drops can be formed to be round or elongated (see FIG. 5b)). The second adhesive material can also be applied to the application section with a specific pattern, such as a cross (FIG. 5a)), or to be U or L shaped.

FIG. 5 a) to c) depict several schematic depictions of an application section having the second adhesive material 50. Several drops of the second adhesive material 50 can be applied to the application section in order to depict a pattern, for example. The volume of the drops can be the same, as depicted in FIG. 5 a), or can be different, as depicted in FIG. 5b). Several drops or only one drop (see FIG. 5c) can be provided, for example. The second adhesive material 50 is then covered by the first adhesive material 52 with a different or the same pattern.

The second adhesive material is, for example, an adhesive curing agent. The second adhesive material can also be an accelerant. The second adhesive material will cure the first adhesive material (for example an epoxy resin). The second adhesive material can be liquid, paste-like or solid. In general, the second adhesive material will cause the crosslinking of a first adhesive material (e.g. an epoxy resin) via a polyaddition or polymerisation reaction. The volume of the second adhesive material can depend on the geometry of the joining component and/or the application section.

The second adhesive material is, as already described, covered by the first adhesive material. The first adhesive material, which encloses the second adhesive material, can be an epoxy resin. The epoxy resin has a solid aggregate state below the crosslinking temperature and can be melted by supplying heat.

The first adhesive material is visible from the outside, while the second adhesive material is not visible from the outside. The volume of the first adhesive material is dependent on the volume of the second adhesive material. The first and second adhesive material can, for example, be arranged to be concentric relative to each other. The second adhesive material forms the core of the joining material before the adhering process. The second adhesive material 50 is arranged, for example, in the middle of the first adhesive material.

The first adhesive material 52 is arranged outwardly. The first adhesive material 52 extends, for example, as depicted in FIG. 1, in the annular groove 30. In other embodiments, the second adhesive material 50 can extend in the annular groove 30. In a further embodiment, both the first and the second adhesive material can extend in the annular groove 30.

In FIG. 6A and FIG. 6B, the second adhesive material 50 (or the adhesive curing agent) in applied in the form of a circular strand. The first adhesive material 52 is then also applied in the form of a circular strand in order to cover the second adhesive material 50. Such a joining material arrangement allows for a good mixture and a good distribution of the joining material. The adhesive strand is preferably removed from the outer face of the flange section 16. The second adhesive material 50 is arranged in the middle of the first adhesive material 52. The second adhesive material 50 and/or the first adhesive material 52 have, for example, a semi-circular cross-section. The second adhesive material 50 forms the core of the joining material.

FIG. 3 schematically depicts method steps for producing the fastener (from left to right).

Firstly, the joining component is provided (FIG. 3 left).

In a second step, the desired volume of the second adhesive material 50 is applied to the flange section 16. The desired volume corresponds, for example, to one drop. Preferably, the second adhesive material 50 is applied to the flange section 16 by means of a volume dosing device Vd. The volume dosing device Vd can be used with or without automatic material guidance. The second adhesive material 50 is liquid, for example in the processing state when warming to c. 80 CC, for example. When cooling down, the second adhesive material 50 can, for example, become paste-like. In particular, when cooling down, the second adhesive material 50 cannot be solid.

In a third step, the first adhesive material is applied over the second adhesive material, such that the first adhesive material completely covers the second adhesive material. Preferably, the first adhesive material 52 is applied to the flange section 16 by means of a volume dosing device Vd. The volume dosing device can be used with or without automatic material guidance. The first adhesive material is liquefied by heating up before application. The liquefied first adhesive material flows around and over the second adhesive material. After solidification, the first adhesive material forms a solid, non-adhesive protective cover around the second adhesive material (that can preferably be paste-like). At the same time, the first adhesive material cotters in the annular groove or the retentive surface structure and is held on the flange section in a secured manner. In another embodiment, the second adhesive material can fill the annular groove. The first adhesive material then adheres sufficiently.

As depicted in FIG. 2, a separating layer 54 can be provided between the first adhesive material and the second adhesive material. The separating layer 54 is applied to the second adhesive material and covers the second adhesive material.

The separating layer 54 forms a physical barrier between the first and second adhesive material in order to prevent an unwanted mixing of the two adhesive materials.

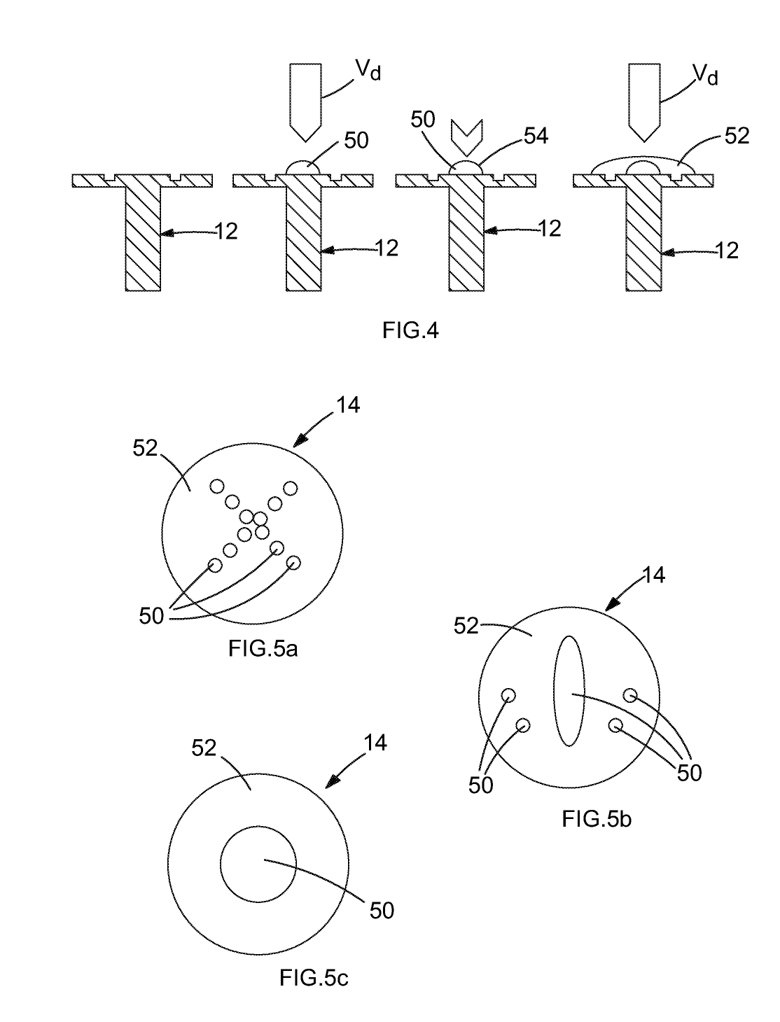

FIG. 4 (from left to right) schematically depicts method steps for producing the fastener having a separating layer. The method depicted in FIG. 4 consists of one step more than that in FIG. 3. After the application of the second adhesive material, the separating layer is applied to the second adhesive material.

The separating layer 54 can be applied to the second adhesive material 50 by means of flame treatment by a silicon dioxide (SiO2, e.g. Pyrosil®). The separating layer 54 is then a silicate layer. A burning flame is then preferably quickly guided over the second adhesive material 50. A silicate layer that is only a few nanometres thick but dense is deposited, for example, on the adhesive curing agent 50 and enables a physical separation from the subsequently applied adhesive resin 52. Since an extremely short exposure by the coating flame is sufficient, only a moderate temperature increase is to be expected.

In another embodiment, a thin polymer layer could be deposited on the second adhesive material 50 by means of plasma flame treatment or plasma polymerisation. This method is a method very similar to the Pyrosil flame treatment with an even lower thermal load.

The separating layer 54 can also be produced by means of powdering by a filler. A sol-gel process, PVD (physical vapour deposition), CVD (chemical vapour deposition), thermal spraying or cold gas spraying can also be provided for applying the separating layer.

In general, each method for depositing a thin layer of polymer, metal or inorganic substances is suitable, as long as the thermal load is kept minimal.

The joining material has a cross-linking temperature, and the separating layer has a melting point that is lower than the cross-linking temperature.

The fastener produced in such a way (with or without a separating layer) can be stored for months at room temperature and can also be transported to the place where the fastener is to be adhered to the support face of a workpiece, such as a car body panel, without a cooling chain. The joining material 14 of the fastener preferably consists of a chemically non-crosslinked or not completely chemically crosslinked adhesive.

In order to adhere the fastener to a support face of a workpiece, such as a car body panel, firstly the fastener 10 is positioned on the support face 34 of the workpiece 36. The flange section (or the joining material) is placed against the support face 34. The joining material 14 is chemically crosslinked in a liquefied and complete manner by means of heat treatment. The complete adherence of the joining material 14 by means of specific adhesion is established during the joining process to the workpiece 34 by means of complete chemical crosslinking of the adhesive. The heating up of the joining material can take place by means of induction, ultrasound or other known heating methods. The joining material can be heated up directly or indirectly. The joining component 12 can be warmed up, for example, and this warms up the joining material via thermal conduction, said joining material being liquefied.

Liquefaction by heating up the joining material 14 can also take place by preheating the workpiece. By placing the joining material 14 on a workpiece 36 heated above the melting point of the joining material 14, the joining material 14 liquefies in the region of the border face (i.e. the face that is directly on the support face). The workpiece heating can, for example, take place via an infrared emitter, but other heating methods can also be provided. In another embodiment, a heating device, for example, can be inserted in the region of the fastener receiver in order to heat up the fastener 10. For this purpose, a heating body, such as a heating coil, for example, in the region of the flange section 16 and/or an infrared emitter aimed at the fastener 10 can be used. A pyrometer can be provided in order to regulate the temperature.

The two melted adhesive layers can react to each other. The joining material can then be mixed in at the same time, such that the first and the second adhesive material form an adhesive matrix. The joining material is warmed up above the crosslinking temperature and an accelerated crosslinking reaction of the joining material takes place.

If a separating layer is provided, firstly the separating layer is dissolved by heating up the joining material 14. As a result, the two adhesive materials (for example adhesive curing agent 50 and adhesive resin 52) are in contact and can mix with each other.

Although exemplary embodiments of the present invention have been shown and described, it will be appreciated by those skilled in the art that changes may be made to these embodiments without departing from the principles and spirit of the invention, the scope of which is defined in the appended claims and their equivalents.

What is claimed is:

1. A fastener joinable to a workpiece, the fastener comprising:
a shaft-shaped anchor section that extends along an anchor axis between a first end portion and a second end portion;
a flange section formed on and extending radially from the first end portion of the anchor section, wherein the flange section is;
an application section located on the flange section;
a joining material pre-applied to and located on the application section, and the joining material is at least partially in a solid state, and the joining material includes a first adhesive material and a different second adhesive material, and the first adhesive material completely covers the second adhesive material.

2. A fastener according to claim 1, wherein the second adhesive material is at least one of a liquid or paste-like or rigid.

3. A fastener according to claim 1, wherein the first adhesive material is in a solid state.

4. A fastener according to claim 1, wherein the first adhesive material is an adhesive resin.

5. A fastener according to claim 1, wherein the first adhesive material is an epoxy resin.

6. A fastener according to claim 1, wherein the second adhesive material is an adhesive curing agent.

7. A fastener according to claim 1, wherein the second adhesive material is an accelerant.

8. A fastener according to claim 1, wherein the first adhesive material and the second adhesive material are separated by a separating layer.

9. A fastener according to claim 8, wherein the joining material has a crosslinking temperature and the separating layer has a melting point, and the melting point is lower than the crosslinking temperature.

10. A fastener according to claim 8, wherein the separating layer is a silicate layer.

11. A fastener according to claim 1, wherein the joining material forms an annular joining material strand having an inner wall around a central opening.

12. A method for producing a fastener joinable to a workpiece, the method comprising the following steps:
providing a fastener component including; a shaft-shaped anchor section that extends along an anchor axis between a first end portion and a second end portion; a flange section formed on and extending radially from the first end portion of the anchor section; and an application section located on the flange section;
applying a heated second adhesive material to at least the application section; and
applying a heated first adhesive material to at least the second adhesive material, such that the first adhesive material completely covers the second adhesive material.

13. A method according to claim 12, and further comprising a step of applying a separating layer to the second adhesive material before the heated first adhesive material is applied.

14. A method according to claim 13, wherein the separating layer is applied by flame treatment by silicon dioxide.

15. A method according to claim 12, and further comprising a step of cooling the joining material down until the first adhesive material is solid.
